(19) United States
(12) Patent Application Publication
(10) Pub. No.: US 2011/0274254 A1
(43) Pub. Date: Nov. 10, 2011

(54) Remote Surveillance System

(76) Inventor: Mi Soon Park, Seoul (KR)

(21) Appl. No.: 13/144,663

(22) PCT Filed: Feb. 25, 2009
(86) PCT No.: PCT/KR2009/000886

§ 371 Date: Jul. 14, 2011

(30) Foreign Application Priority Data
Jan. 15, 2009 (KR) 1020090003165

(51) Int. Cl. H04M 11/04

(52) U.S. Cl. 379/40; 379/39

(57) ABSTRACT

The present invention relates to a remote surveillance system. More specifically, the present invention concerns a remote surveillance system that is able to monitor a remote place efficiently by checking for disconnection and malfunction of surveillance equipment installed at the remote place. In order to achieve the object, the surveillance system according to the invention comprises: a remote surveillance unit that is installed and monitors conditions at the remote place and generates an alarm signal in the event of emergency; an information management server that receives the alarm signal from the remote surveillance unit and transmits the received alarm signal to a user terminal; and a network that connects the remote surveillance unit to the information management unit.

### BACKGROUND OF THE INVENTION

1. Field of the Invention

The present invention relates to a remote surveillance system, more specifically, for checking the disconnection with monitoring devices located at remote places and the breakdown of the monitoring devices, thereby efficiently monitoring the remote places.

2. Description of the Related Art

There have been various conventional systems for monitoring theft or fire which may happen at remote places (e.g., vacant offices or houses). However, most of these conventional systems are supervised and managed by private security companies, and require high maintenance costs due to their controlling and dispatching activities.

Accordingly, there has been a need for a surveillance system which can monitor a remote place with a low maintenance cost, judge on its own whether the breakdown or damage happens at the remote place, and inform a user of the situation of the remote place in real time.

### SUMMARY OF THE INVENTION

A purpose of the present invention is to provide a remote surveillance system which can monitor a remote place with a low installation cost and a low maintenance cost, and promptly and directly transmit information about a dangerous situation, which has happened at the remote place, to a user in real time, as a solution for the problem of the conventional systems.

Furthermore, another purpose of the present invention is to provide a remote surveillance system which can detect the breakdown of the system and the damage of a network on its own, and promptly inform a user thereof.

The present invention for achieving the above purposes is a remote surveillance system for detecting a dangerous situation of a remote place and transmitting a danger-signal to a user's terminal, the remote surveillance system comprising: a remote monitoring unit installed at the remote place to monitor a situation of the remote place and generate the danger-signal if the dangerous situation happens; an information management server for receiving the danger-signal from the remote monitoring unit and transmitting the danger-signal to the user's terminal; and a network for connecting the remote monitoring unit and the information management server.

Preferably, the network is PSTN, BcN or a wireless communication network. The network comprises: an exchanger; and a transmission line for connecting the exchanger, the remote monitoring unit and the information management server.

If the information management server performs a system-malfunction-checking (i.e., disconnection-checking and breakdown-checking) function, the information management server calls the remote monitoring unit, whereby the network sends a call-signal to the remote monitoring unit; if the remote monitoring unit receives the call-signal, the remote monitoring unit keeps an on-hook state until the number of the call-signal reaches a reference call-signal number; if the information management server receives a first call-waiting tone, the information management server is converted to an on-hook state, thereby stopping the network from sending the call-signal to the remote monitoring unit; if the remote monitoring unit receives the call-signal, the number of which is less than or equal to the reference call-signal number, the remote monitoring unit calls the information management server, whereby the network sends a responsive call-signal to the information management server; if the information management server receives the responsive call-signal, the information management server judges that a system-malfunction state has not happened; and if the network sends the responsive call-signal and the remote monitoring unit receives a first call-waiting tone from the network, the remote monitoring unit is converted to an on-hook state, thereby stopping the network from sending the responsive call-signal to the information management server.

If the call-signal includes CID data, the remote monitoring unit can receive only the call-signal which is generated when the information management server calls the remote monitoring unit, and the information management server can receive only the responsive call-signal which is generated when the remote monitoring unit calls the information management server. Preferably, the reference call-signal number is one or two.

The information management server comprises a control-data storage unit. If the information management server does not receive the responsive call-signal, the information management server judges that the system-malfunction state has happened, and the system-malfunction state is recorded on the control-data storage unit. If the remote monitoring unit is busy, the information management server re-calls the remote monitoring unit after a certain waiting time during a certain term, whereby the network re-sends the call-signal to the remote monitoring unit.

If the information management server transmits data to the remote monitoring unit, the information management server calls the remote monitoring unit, whereby the network sends a call-signal to the remote monitoring unit; after the information management server receives a first call-waiting tone from the network, the information management server keeps an off-hook state, whereby the network continues to send the call-signal to the remote monitoring unit; and if the remote monitoring unit receives the call-signal, the number of which is more than a reference call-signal number, the remote monitoring unit is converted to an off-hook state and receives the data from the information management server.

If the remote monitoring unit performs a system-malfunction-checking function, the remote monitoring unit calls the information management server according to a checking period, whereby the network sends a call-signal to the information management server; if the information management server receives the call-signal, the information management server keeps an on-hook state until the number of the call-signal reaches a reference call-signal number; if the remote monitoring unit receives a first call-waiting tone from the network, the remote monitoring unit is converted to an on-hook state, thereby stopping the network from sending the call-signal to the information management server; and if the information management server receives the call-signal, the number of which is less than or equal to the reference call-signal number, the information management server judges that a system-malfunction state has not happened.

If the call-signal includes CID data, the information management server can receive only the call-signal which is generated when the remote monitoring unit calls the information management server.

The information management server comprises a control-data storage unit. If the information management server does not receive the call-signal after the checking period, the information management server judges that the system-malfunction state has happened and the system-malfunction state is recorded on the control-data storage unit. If the information management server is busy, the remote monitoring unit re-calls the information management server after a certain waiting time during a certain term, whereby the network re-sends the call-signal to the information management server.

If the remote monitoring unit transmits data to the information management server, the remote monitoring unit calls the information management server, whereby the network sends a call-signal to the information management server; after the remote monitoring unit receives a first call-waiting tone from the network, the remote monitoring unit keeps an off-hook state, whereby the network continues to send the call-signal to the information management server; and if the information management server receives the call-signal, the number of which is more than a reference call-signal number, the information management server is converted to an off-hook state and receives the data from the remote monitoring unit.

The remote monitoring unit comprises: a monitoring device for detecting the dangerous situation of the remote place; a video recording device for recording the dangerous situation of the remote place and generating the danger-signal if the monitoring device detects the dangerous situation; and a signal-controlling unit for transmitting the danger-signal through the network. Preferably, the monitoring device is a heat-ray monitoring device, an infrared-ray monitoring device, a plosive monitoring device, an open-close monitoring device, a smoke monitoring device, a gas leakage monitoring device or combinations thereof.

The signal-controlling unit monitors whether a system-malfunction state of the monitoring device or the video recording device has happened with a certain time interval by an inquiry of the information management server or on its own, and periodically reports whether the system-malfunction state has happened to the information management server by establishing a channel to the information management server. The signal-controlling unit periodically receives a report of whether the system-malfunction state has happened from the monitoring device or the video recording device.

The monitoring device or the video recording device monitors whether a system-malfunction state of the monitoring device or the video recording device has happened with a certain time interval by an inquiry of the information management server or on its own, and periodically reports whether the system-malfunction state has happened to the information management server by establishing a channel to the information management server.

The information management server comprises a control-data storage unit, and the system-malfunction state is recorded on the control-data storage unit. The information management server comprises a control-data storage unit and inquires of the signal-controlling unit, the monitoring device or the video recording device whether a system-malfunction state has happened with a certain interval by using a charging manner. The system-malfunction state is recorded on the control-data storage unit.

The information management server transmits the danger-signal received from the remote monitoring unit to the user's terminal in a form of short message data or message data to which video data are attached, which is receivable in the user's terminal. The remote monitoring unit transmits the danger-signal to the user's terminal in a form of short message data or message data to which video data are attached, which is receivable in the user's terminal.

The information management server comprises a control-data storage unit which stores the danger-signal received from the remote monitoring unit, checking period data, user authentication data and monitoring unit authentication data. The checking period data, user authentication data and monitoring unit authentication data are directly input to the information management server. The user authentication data and the monitoring unit authentication data is used for allowing only a registered user and a registered equipment.

The information management server comprises: a control-data storage unit for storing breakdown information of the remote monitoring unit, the network disconnection information and the danger-signal; a message transmitting unit for transforming the danger-signal to a user's terminal-receivable message, transmitting the user's terminal-receivable message to a user's terminal, and attaching to the user's terminal-receivable message a confirmation text which transmits a confirmation message to the information management server, the confirmation message informing that the user has received or read the user's terminal-receivable message; and a message-receipt-confirming unit for receiving the confirming message, wherein if the message-receipt-confirming unit does not receive the confirmation message, the danger-signal which is stored in the control-data storage unit is re-sent to the user's terminal by the message transmitting unit.

The effect of a remote surveillance system according to the present invention, which is achieved by the above constitution, is as follows.

(1) A user can monitor whether a dangerous situation such as theft, intrusion, fire or gas leak happens at a vacant remote place, and can promptly handle it without going to the remote place in person since the dangerous situation of the remote place is directly transmitted to the user's cell phone in real time in the form of a text message or a video message.

(2) Monitoring cost and maintenance costs can be minimized because the remote place is monitored by a simple constitution through a network such as PSTN, BcN or a wireless communication line.

(3) The remote surveillance system can periodically monitor its breakdown or disconnection on its own without generating a cost for using a network and can promptly inform the user of its breakdown or disconnection, thereby minimizing its monitoring gap and maintenance cost.

### BRIEF DESCRIPTION OF THE DRAWING

FIG. 1 is a schematic view of a remote surveillance system according to the present invention.

### DETAILED DESCRIPTION OF THE INVENTION

Hereinafter, a preferred embodiment of the present invention will be explained in detail with reference to the accompanying drawings. As for the constitution of the present invention, if an explanation about the relevant publicly known art or constitution is regarded as unnecessarily confusing the gist of the present invention, it will be omitted.

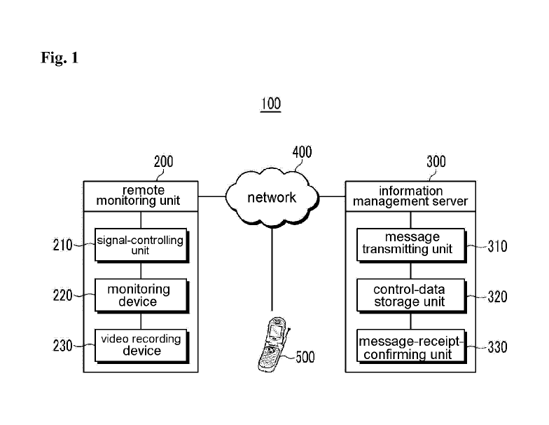

FIG. 1 is a schematic view of a remote surveillance system according to the present invention.

According to the first embodiment of the present invention, a remote surveillance system 100 comprises a remote monitoring unit 200, an information management server 300 and a network 400. The term “remote place” is defined as a place which is far away from a user's current location and may be exemplified as a vacant office, factory or house.

The remote monitoring unit 200 is located at the remote place, monitors a dangerous situation which may happen at the remote place, and generates a danger-signal if the dangerous situation happens. The term “dangerous situation” is defined as an event which may cause the user's property loss or casualties (e.g., intrusion, theft, fire, gas leak, etc.). The term “danger-signal” is defined as various types of data which can inform the user of the danger situation of the remote place (e.g., short text message data, video data, voice data, etc.).

The remote monitoring unit 200 may comprise a signal-controlling unit 210, a monitoring device 220 and a video recording device 230.

The signal-controlling unit 210 may be located at the remote place or, if necessary, at a place which is far away from the remote place. The signal-controlling unit 210 may transmit the generated danger-signal to the information management server 300 through the network 400 or directly transmit the generated danger-signal to the user's terminal 500.

The monitoring device 220 is a monitoring device of the remote place, such as a heat-ray monitoring device, an infrared-ray monitoring device, a plosive monitoring device, an open-close monitoring device, a smoke monitoring device, a gas leakage monitoring device, etc. Any monitoring device which can detect the intrusion, fire, etc. of the remote place can be used as the monitoring device 220, and a combination of the individual monitoring devices is also available.

If the monitoring device 220 detects the dangerous situation, the video recording device 230 generates the danger-signal by filming the remote place, and preferably generates for a certain time video data which have a transmittable size.

The information management server 300 receives the danger-signal, which the remote monitoring unit 200 generates, through the network 400 and transmits the danger-signal to the user's terminal 500. The term “terminal” is defined as a device for wire or wireless communication with the information management server 300. Hereinafter, a cell phone will be exemplified as the terminal 500.

The information management server 300 comprises a message transmitting unit 310 which can transmit the danger-signal, which the information management server 300 receives from the remote monitoring unit 200, to the user's cell phone 500 in the form of a short text data message (SMS) or a video-data-attached text data message (MMS) which is receivable in the user's cell phone 500.

The remote monitoring unit 200—i.e., the signal-controlling unit 210, the monitoring device 220 or the video recording device 230—may transform the danger-signal to the short text data message (SMS) or the video-data-attached text data message (MMS), which is receivable in the user's cell phone 500 and transmit it to the information management server 300 or directly to the user's cell phone 500.

The message transmitting unit 310 attaches a text message confirmation tag to the text data message, whereby a receipt confirmation message and/or a read confirmation message informing that the user receives and/or reads the text data message can be transmitted to the information management server 300, and a message-receipt-confirming unit 330 receives the receipt confirmation message and/or the read confirmation message. The term “receipt confirmation message” is defined as a message which is re-transmitted to a calling party in order to inform that the text data message reaches the user's cell phone 500, and the term “read confirmation message” is defined as a message which is re-transmitted to the calling party in order to inform that the user reads the text data message which is transmitted to the cell phone 500. The term “confirmation message” includes both of “receipt confirmation message” and “read confirmation message.”

The information management server 300 may comprise a control-data storage unit which stores the danger-signal transmitted from the remote monitoring unit 200, various checking period data, user authentication data (e.g., user ID, password, etc.), monitoring unit authentication data, etc. Various checking period data, the user authentication data, the monitoring unit authentication data, etc. may be directly input to the information management server 300.

The danger signal which is stored in the control-data storage unit 320 can be re-transmitted to the user. Particularly, in case the message-receipt-confirming unit 330 cannot receive the receipt confirmation message and/or the read confirmation message, the message transmitting unit 310 can re-transmit the danger-signal, which is stored in the control-data storage unit 320, to the user's cell phone 500. The user authentication data and the monitoring unit authentication data, which are stored or directly input, are used to allow only a registered user and equipment to be used.

The network 400 is defined as a network which connects the remote monitoring unit 200 and the information management server 300, thereby transmitting data (e.g., PSTN (Public Switched Telephone Network), BcN (Broadband Convergence Network) or a wireless communication network). The network comprises at least one exchanger and a transmission line, and the remote monitoring unit 200 and the information management server 300 are connected with each other through the exchanger via the transmission line. Since the network 400 is a publicly known network, its detailed explanation will be omitted.

Hereinafter, the system-malfunction-checking function of the remote surveillance system according to a first embodiment of the present invention will be explained. The term “system-malfunction” includes both “disconnection” and “breakdown.” The term “disconnection” means that the transmission line which connects the remote monitoring unit 200 and the exchanger of the network 400 is disconnected, and the term “breakdown” means that the remote monitoring unit 200 is out of order.

In the system-malfunction-checking function of the remote surveillance system according to the first embodiment, the information management server 300 periodically checks the remote monitoring unit 200 in a manner that does not generate costs by not establishing a channel. Hereinafter, it will be exemplified that the remote monitoring unit 200 and the information management server 300 are connected with each other via the network 400 including one exchanger, but the claimed scope of the present invention will not be restricted to this exemplified constitution.

The information management server 300 calls the signal-controlling unit 210, the monitoring device 220 or the video recording device 230 of the remote monitoring unit 200 according to a checking period, whereby the network 400 (i.e., the exchanger of the network 400) sends a call-signal to the signal-controlling unit 210, the monitoring device 220 or the video recording device 230 of the remote monitoring unit 200, and sends a call-waiting tone to the information management server 300.

The term “call-signal” is defined as a signal which the exchanger sends to a receiving party's terminal to generate a ringtone of the receiving party's terminal CID (Calling Identity Delivery) data may be inserted between the call-signals, whereby the remote monitoring unit 200 can identify whether the call-signal which the remote monitoring unit 200 receives is the call-signal which is generated by the information management server 300. The term “call-waiting tone” is defined as a signal which the exchanger of the network 400 sends to a calling party's terminal and is automatically sent to the calling party even when the disconnection happens at the receiving party's terminal. The call-waiting tone may be set to have a specified sound.

The call-signal may be directly sent to each of the signal-controlling unit 210, the monitoring device 220 and the video recording device 230 of the remote monitoring unit 200, or sent to only the signal-controlling unit 210. Hereinafter, it will be exemplified that the call-signal is sent to only the signal-controlling unit 210.

The term “checking period” is defined as a period for checking the system-malfunction, or a period which is set to send the call-signal (i.e., a period for sending the call-signal). The checking period may be unrestrictedly set in the information management server 300 and transmitted to the remote monitoring unit 200 via the network 400.

On the basis of the CID data which are inserted between the first call-signal and the second call-signal, the signal-controlling unit 210 determines whether the call-signal is sent by the calling of the information management server 300. If the call-signal is not sent by the calling of the information management server 300, the signal-controlling unit 210 keeps an on-hook state so as not to establish a channel. The term “on-hook state” is defined as a state of hanging up a receiver, and does not generate costs because no channel is established.

If the signal-controlling unit 210 judges by the CID data that the call-signal is sent by the calling of the information management server 300, it keeps an on-hook state until the number of the received call-signals becomes a reference call-signal number. When the number of the received call-signals becomes more than the reference call-signal number, the on-hook state is converted to an off-hook state to establish the channel, whereby data can be transmitted through the channel, which generates costs.

The term “reference call-signal number” is defined as a reference number which the user sets for the signal-controlling unit 210 to judge whether the call-signal which is generated by the calling of the information management server 300 is a system-malfunction-checking signal or a useful data-transmitting signal. The reference call-signal number is set as the number which can secure the time for which the calling party can receive the first call-waiting tone, and is preferably set as one (1) or two (2).

If the reference call-signal number is set as two (2), the signal-controlling unit 210 keeps an on-hook state until it receives the second call-signal, and when the third call-signal is received, the on-hook state is converted to an off-hook state.

While the signal-controlling unit 210 is receiving the first call-signal or the second call-signal, the information management server 300 receives the first call-waiting tone from the exchanger. When the information management server 300 receives the first call-waiting tone, the information management server 300 is immediately converted to an on-hook state, thereby stopping calling the signal-controlling unit 210, and the call-signals are no longer sent to the signal-controlling unit 210. Finally, since the signal-controlling unit 210 just receives the first call-signal or the second call-signal, it still keeps the on-hook state. Since the number of the received call-signals is not more than the reference call-signal number, the signal-controlling unit 210 judges that the calling of the information management server 300 is for system-malfunction-checking, and carries out the following steps.

The signal-controlling unit 210 generates a responsive call-signal in order to inform the information management server 300 that the signal-controlling unit 210 has not been out of order, or that the transmission line between the signal-controlling unit 210 and the exchanger has not been disconnected. The signal-controlling unit 210 calls the information management server 300, whereby the exchanger sends the responsive call-signal to the information management server 300. At the same time, the exchanger sends a call-waiting tone to the signal-controlling unit 210.

If the information management server 300, which is waiting for the responsive call-signal after stopping calling the signal-controlling unit 210, receives the responsive call-signal, it judges that the transmission line between the signal-controlling unit 210 and the exchanger has not been disconnected, or that the signal-controlling unit 210 has not been out of order. Here, the signal-controlling unit 210 is converted to an on-hook state when it receives the first call-waiting tone from the exchanger.

In case the transmission line between the signal-controlling unit 210 and the exchanger has been disconnected, or the signal-controlling unit 210 has been out of order, the signal-controlling unit 210 cannot receive the call-signal which is sent by the calling of the information management server 300, and thus the responsive call-signal cannot be sent to the information management server 300. If the information management server 300 which made the exchanger send the call-signal for system-malfunction-checking does not receive the responsive call-signal, it judges that the system-malfunction state has happened. Therefore, the message transmitting unit 310 transmits a system-malfunction message to the user's cell phone 500, whereby the user can repair the system-malfunction state. The system-malfunction state is recorded and stored in the control-data storage unit 320.

In case the information management server 300 calls the signal-controlling unit 210 to check the system-malfunction state or to transmit data but the line is busy (i.e., the exchanger sends a busy tone, an overload tone, etc. to the information management server 300), the information management server 300 re-calls the signal-controlling unit 210 after a certain waiting time during a certain term, whereby the exchanger re-sends the call-signal to the signal-controlling unit 210. If the busy state is repeated more than a certain number of times, the message transmitting unit 310 transmits a busy line message to the user's cell phone 500, whereby the user can check the busy state.

In case the information management server 300 transmits data to the signal-controlling unit 210, the information management server 300 calls the signal-controlling unit 210, whereby the exchanger of the network 400 sends a call-signal to the signal-controlling unit 210. Although the information management server 300 receives the first call-waiting tone which corresponds to the call-signal, the information management server 300 keeps an off-hook state and the exchanger does not stop sending the call-signal to the signal-controlling unit 210. Therefore, the signal-controlling unit 210 receives the call-signals more than twice (if the reference call-signal number is set as two), and then is converted to an off-hook state to establish a channel and receive the data from the information management server 300. Examples of the transmitted data are maintenance information (e.g., inquiry about breakdown of a device), control data (e.g., checking period data, user authentication data such as a user's ID and a password, and monitoring unit authentication data) and control data download information, etc.

In case the call-signal is sent only to the signal-controlling unit 210 of the remote monitoring unit 200, the signal-controlling unit 210 may check the system-malfunction state for the monitoring device 220 and the video recording device 230 in the same manner as the above system-malfunction-checking function which does not generate costs. Furthermore, the signal-controlling unit 210 directly sends a system-malfunction-checking call-signal or another call-signal to the monitoring device 220 and the video recording device 230, and the monitoring device 220 and the video recording device 230 directly send a responsive call-signal to the signal-controlling unit 210 to judge whether the system-malfunction state has happened.

Hereinafter, a remote surveillance system according to the second embodiment of the present invention will be explained.

In the first embodiment, in order to check the system-malfunction state, the information management server 300 calls the signal-controlling unit 210, the monitoring device 220 or the video recording device 230, whereby the network 400 sends the call-signal to the signal-controlling unit 210, the monitoring device 220 or the video recording device 230, and then the signal-controlling unit 210, the monitoring device 220 or the video recording device 230 calls the information management server 300, whereby the network 400 sends the responsive call-signal to the information management server 300. In the second embodiment, however, the signal-controlling unit 210, the monitoring device 220 or the video recording device 230 calls the information management server 300, whereby the call-signal is sent to the information management server 300 so that the disconnection of the network 400 or the breakdown of the remote monitoring unit 200 is checked. Hereinafter, it will be exemplified that the call-signal is sent to the information management server 300 by the calling of the signal-controlling unit 210.

In the remote surveillance system according to the second embodiment, the signal-controlling unit 210 periodically checks the system-malfunction state of the information management server 300 in a manner that does not generate costs by not establishing the channel.

The signal-controlling unit 210 calls the information management server 300 according to the checking period, whereby the exchanger of the network 400 sends the call-signal to the information management server 300. The checking period may be unrestrictedly set in the signal-controlling unit 210 and be transmitted to the information management server 300 via the network 400. Furthermore, the checking period may be downloaded from the information management server 300 to the signal-controlling unit 210 via the network 400.

On the basis of the CID data which are inserted between the first call-signal and the second call-signal, the information management server 300 determines whether the call-signal is sent by the calling of the signal-controlling unit 210. If the call-signal is not sent by the calling of the signal-controlling unit 210, the information management server 300 keeps an on-hook state so as not to respond to the call-signal.

If the information management server 300 judges by the CID data that the call-signal is sent by the calling of the signal-controlling unit 210, the information management server 300 keeps an on-hook state until the number of the received call-signals becomes the reference call-signal number. When the number of the received call-signals becomes more than the reference call-signal number, the on-hook state is converted to an off-hook state to establish the channel.

If the reference call-signal number is set as two (2), the information management server 300 keeps an on-hook state until it receives the second call-signal, and when the third call-signal is received, the on-hook state is converted to an off-hook state.

While the information management server 300 is receiving the first call-signal or the second call-signal, the signal-controlling unit 210 receives the first call-waiting tone from the exchanger. When the signal-controlling unit 210 receives the first call-waiting tone, the signal-controlling unit 210 is immediately converted to an on-hook state, thereby stopping calling the information management server 300, and the call-signals are no longer sent to the information management server 300. Finally, since the information management server 300 just receives the first call-signal or the second call-signal, it still keeps the on-hook state. Since the number of the received call-signals is not more than the reference call-signal number, the information management server 300 judges that the calling of the signal-controlling unit 210 is for system-malfunction-checking.

Since the information management server 300 receives the call-signal from the signal-controlling unit 210, the information management server 300 judges that the network 400 has not been disconnected and that the signal-controlling unit 210 has not been out of order. This system state is recorded and stored in the control-data storage unit 320.

In case the transmission line between the signal-controlling unit 210 and the exchanger has been disconnected, or the signal-controlling unit 210 has been out of order, the information management server 300 cannot receive the call-signal which is sent by the calling of the signal-controlling unit 210 according to the checking period, and then judges that the system-malfunction state has happened. Accordingly, the message transmitting unit 310 transmits a system-malfunction message to the user's cell phone 500, whereby the user can repair the system-malfunction state. The system-malfunction state is recorded and stored in the control-data storage unit 320.

In case the signal-controlling unit 210 calls the information management server 300 to check the system-malfunction state or to transmit data but the line is busy (i.e., the exchanger sends a busy tone, an overload tone, etc. to the signal-controlling unit 210), the signal-controlling unit 210 re-calls the information management server 300 after a certain waiting time during a certain term, whereby the exchanger re-sends the call-signal to the information management server 300. If the busy state is repeated more than a certain number, the signal-controlling unit 210 transmits a busy line message to the user's cell phone 500, whereby the user can check the busy state.

In case the signal-controlling unit 210 transmits data to the information management server 300, the signal-controlling unit 210 calls the information management server 300, whereby the exchanger of the network 400 sends a call-signal to the information management server 300. Although the signal-controlling unit 210 receives the first call-waiting tone which corresponds to the call-signal, the signal-controlling unit 210 keeps an off-hook state and the exchanger does not stop sending the call-signal to the information management server 300. Therefore, the information management server 300 receives the call-signals more than twice (if the reference call-signal number is set as two), and then is converted to an off-hook state to establish a channel and receive the data from the signal-controlling unit 210. Examples of the transmitted data are maintenance information (e.g., inquiry about breakdown of a device), control data (e.g., checking period data, user authentication data such as a user's ID and a password, and a monitoring unit authentication data) and control data download information, etc.

Here, it was explained that the signal-controlling unit 210 performs the system-malfunction-checking function for the information management server 300. However, the monitoring device 220 and the video recording device 230 may also perform the system-malfunction-checking function for the information management server 300 in the same manner.

Furthermore, the signal-controlling unit 210 may transmit data and check the system-malfunction state of the monitoring device 220 and the video recording device 230 in the same manner that the above-explained system checks the system-malfunction state without generating costs. Alternatively, the signal-controlling unit 210 directly sends a system-malfunction-checking call-signal or another call-signal to the monitoring device 220 and the video recording device 230, and then the monitoring device 220 and the video recording device 230 directly send a responsive call-signal to the signal-controlling unit 210, whereby the system-malfunction state can be checked. Also, after the signal-controlling unit 210 directly sends a call-signal or another call-signal to the monitoring device 220 and the video recording device 230, data transmission is finished, and then the monitoring device 220 and the video recording device 230 directly send another data-transmission-completion signal to the monitoring device 220 and the video recording device 230.

The monitoring device 220 and the video recording device 230 may use the above two manners to check the system-malfunction state of the signal-controlling unit 210 and transmit data to the signal-controlling unit 210.

The signal-controlling unit 210 may periodically check the system-malfunction states of the monitoring device 220 and the video recording device 230 by inquiry of the information management server 300 or on its own, and periodically report a checking result to the information management server 300 through the channel which generates costs. Alternatively, the monitoring device 220 and the video recording device 230 may periodically report their system-malfunction states to the signal-controlling unit 210, and then the signal-controlling unit 210 may periodically send this report to the information management server 300 through the channel which generates costs. Alternatively, the monitoring device 220 and the video recording device 230 may directly report their system-malfunction states to the information management server 300 through the channel which generates costs. The system-malfunction state is recorded in the control-data storage unit 320.

Alternatively, the information management server 300 may periodically inquire of each of the signal-controlling unit 210, the monitoring device 220 and the video recording device 230 or of the signal-controlling unit 210 about the system-malfunction state through the channel which generates costs, and record the checking result in the control-data storage unit 320.

The system-malfunction-checking function of the remote surveillance system of the present invention allows the user to prevent invaders from neutralizing a surveillance system by cutting off a communication line or destroying a wireless base station or a repeater, at low cost and by using simple constitutions.

From the above embodiments of the present invention, it is noted that modifications and variations could be made by a person skilled in the art in light of the above teachings. Therefore, it should be understood that changes may be made for a particular embodiment of the present invention within its scope and spirit outlined by the appended claims.

What is claimed is:

1. A remote surveillance system for detecting a dangerous situation of a remote place and transmitting a danger-signal to a user's terminal, the remote surveillance system comprising:
a remote monitoring unit installed at the remote place to monitor a situation of the remote place and generate the danger-signal if the dangerous situation happens;
an information management server for receiving the danger-signal from the remote monitoring unit and transmitting the danger-signal to the user's terminal; and
a network for connecting the remote monitoring unit and the information management server.

2. The remote surveillance system according to claim 1, wherein
the network is PSTN, BcN or a wireless communication network.

3. The remote surveillance system according to claim 2, wherein the network comprises:
an exchanger; and
a transmission line for connecting the exchanger, the remote monitoring unit and the information management server.

4. The remote surveillance system according to claim 1, wherein
if the information management server performs a system-malfunction-checking function, the information management server calls the remote monitoring unit, whereby the network sends a call-signal to the remote monitoring unit,
wherein if the remote monitoring unit receives the call-signal, the remote monitoring unit keeps an on-hook state until the number of the call-signal reaches a reference call-signal number,
wherein if the information management server receives a first call-waiting tone, the information management server is converted to an on-hook state, thereby stopping the network from sending the call-signal to the remote monitoring unit,
wherein if the remote monitoring unit receives the call-signal, the number of which is less than or equal to the reference call-signal number, the remote monitoring unit calls the information management server, whereby the network sends a responsive call-signal to the information management server, and
wherein if the information management server receives the responsive call-signal, the information management server judges that a system-malfunction state has not happened.

5. The remote surveillance system according to claim 4, wherein
if the network sends the responsive call-signal and the remote monitoring unit receives a first call-waiting tone from the network, the remote monitoring unit is converted to an on-hook state, thereby stopping the network from sending the responsive call-signal to the information management server.

6. The remote surveillance system according to claim 4, wherein
the call-signal includes CID data, and the remote monitoring unit receives only the call-signal which is generated when the information management server calls the remote monitoring unit.

7. The remote surveillance system according to claim 4, wherein
the call-signal includes CID data and the information management server receives only the responsive call-signal which is generated when the remote monitoring unit calls the information management server.

8. The remote surveillance system according to claim 4, wherein
the reference call-signal number is one or two.

9. The remote surveillance system according to claim 4, wherein
if the information management server does not receive the responsive call-signal, the information management server judges that the system-malfunction state has happened, and transmits a system-malfunction signal to the user's terminal.

10. The remote surveillance system according to claim 4, wherein
the information management server comprises a control-data storage unit, and
wherein if the information management server does not receive the responsive call-signal, the information management server judges that the system-malfunction state has happened, and the system-malfunction state is recorded on the control-data storage unit.

11. The remote surveillance system according to claim 4, wherein
if the remote monitoring unit is busy, the information management server re-calls the remote monitoring unit after a certain waiting time during a certain term, whereby the network re-sends the call-signal to the remote monitoring unit.

12. The remote surveillance system according to claim 1, wherein
if the information management server transmits data to the remote monitoring unit, the information management server calls the remote monitoring unit, whereby the network sends a call-signal to the remote monitoring unit,
wherein after the information management server receives a first call-waiting tone from the network, the information management server keeps an off-hook state, whereby the network continues to send the call-signal to the remote monitoring unit, and
wherein if the remote monitoring unit receives the call-signal, the number of which is more than a reference call-signal number, the remote monitoring unit is converted to an off-hook state and receives the data from the information management server.

13. The remote surveillance system according to claim 1, wherein
if the remote monitoring unit performs a system-malfunction-checking function, the remote monitoring unit calls the information management server according to a checking period, whereby the network sends a call-signal to the information management server,
wherein if the information management server receives the call-signal, the information management server keeps an on-hook state until the number of the call-signal reaches a reference call-signal number,
wherein if the remote monitoring unit receives a first call-waiting tone from the network, the remote monitoring unit is converted to an on-hook state, thereby stopping the network from sending the call-signal to the information management server, and
wherein if the information management server receives the call-signal, the number of which is less than or equal to the reference call-signal number, the information management server judges that a system-malfunction state has not happened.

14. The remote surveillance system according to claim 13, wherein
the call-signal includes CID data, and the information management server receives only the call-signal which is generated when the remote monitoring unit calls the information management server.

15. The remote surveillance system according to claim 13, wherein
the reference call-signal number is one or two.

16. The remote surveillance system according to claim 13, wherein
if the information management server does not receive the call-signal after the checking period, the information management server judges that the system-malfunction state has happened and transmits a system-malfunction signal to the user's terminal.

17. The remote surveillance system according to claim 13, wherein
the information management server comprises a control-data storage unit, and
wherein if the information management server does not receive the call-signal after the checking period, the information management server judges that the system-malfunction state has happened and the system-malfunction state is recorded on the control-data storage unit.

18. The remote surveillance system according to claim 13, wherein
if the information management server is busy, the remote monitoring unit re-calls the information management server after a certain waiting time during a certain term, whereby the network re-sends the call-signal to the information management server.

19. The remote surveillance system according to claim 1, wherein
if the remote monitoring unit transmits data to the information management server, the remote monitoring unit calls the information management server, whereby the network sends a call-signal to the information management server,
wherein after the remote monitoring unit receives a first call-waiting tone from the network, the remote monitoring unit keeps an off-hook state, whereby the network continues to send the call-signal to the information management server, and
wherein if the information management server receives the call-signal, the number of which is more than a reference call-signal number, the information management server is converted to an off-hook state and receives the data from the remote monitoring unit.

20. The remote surveillance system according to claim 1, wherein the remote monitoring unit comprises:
a monitoring device for detecting the dangerous situation of the remote place;
a video recording device for recording the dangerous situation of the remote place and generating the danger-signal if the monitoring device detects the dangerous situation; and
a signal-controlling unit for transmitting the danger-signal through the network.

21. The remote surveillance system according to claim 20, wherein
the monitoring device is a heat-ray monitoring device, an infrared-ray monitoring device, a plosive monitoring device, an open-close monitoring device, a smoke monitoring device, a gas leakage monitoring device or combinations thereof.

22. The remote surveillance system according to claim 20, wherein
the signal-controlling unit monitors whether a system-malfunction state of the monitoring device or the video recording device has happened with a certain time interval by an inquiry of the information management server or on its own, and periodically reports whether the system-malfunction state has happened to the information management server by establishing a channel to the information management server.

23. The remote surveillance system according to claim 22, wherein
the signal-controlling unit periodically receives a report of whether the system-malfunction state has happened from the monitoring device or the video recording device.

24. The remote surveillance system according to claim 20, wherein
the monitoring device or the video recording device monitors whether a system-malfunction state of the monitoring device or the video recording device has happened with a certain time interval by an inquiry of the information management server or on its own, and periodically reports whether the system-malfunction state has happened to the information management server by establishing a channel to the information management server.

25. The remote surveillance system according to claim 22 or 24, wherein
the information management server comprises a control-data storage unit, and the system-malfunction state is recorded on the control-data storage unit.

26. The remote surveillance system according to claim 20, wherein
the information management server comprises a control-data storage unit and inquires of the signal-controlling unit, the monitoring device or the video recording device whether a system-malfunction state has happened with a certain interval by using a charging manner, and
wherein the system-malfunction state is recorded on the control-data storage unit.

27. The remote surveillance system according to claim 1, wherein
the information management server transmits the danger-signal received from the remote monitoring unit to the user's terminal in a form of short message data or message data to which video data are attached, which is receivable in the user's terminal.

28. The remote surveillance system according to claim 1, wherein
the remote monitoring unit transmits the danger-signal to the user's terminal in a form of short message data or message data to which video data are attached, which is receivable in the user's terminal.

29. The remote surveillance system according to claim 1, wherein
the information management server comprises a control-data storage unit which stores the danger-signal received from the remote monitoring unit, checking period data, user authentication data and monitoring unit authentication data.

30. The remote surveillance system according to claim 1, wherein
checking period data, user authentication data and monitoring unit authentication data are directly input to the information management server.

31. The remote surveillance system according to claim 29 or 30, wherein
the user authentication data and the monitoring unit authentication data is used for allowing only a registered user and a registered equipment.

32. The remote surveillance system according to claim 1, wherein the information management server comprises:
a control-data storage unit for storing breakdown information of the remote monitoring unit, the network disconnection information and the danger-signal;
a message transmitting unit for transforming the danger-signal to a user's terminal-receivable message, transmitting the user's terminal-receivable message to a user's terminal, and attaching to the user's terminal-receivable message a confirmation text which transmits a confirmation message to the information management server, the confirmation message informing that the user has received or read the user's terminal-receivable message; and
a message-receipt-confirming unit for receiving the confirming message,
wherein if the message-receipt-confirming unit does not receive the confirmation message, the danger-signal which is stored in the control-data storage unit is re-sent to the user's terminal by the message transmitting unit.
